(19) United States
(12) Patent Application Publication
(10) Pub. No.: US 2011/0121562 A1
(43) Pub. Date: May 26, 2011

(54) Hybrid tube connector port

(76) Inventors: Jonathan Clark Swift, Cambridge (GB); Charles Clinton Gray, Parker, CO (US); Randall Mark Leasure, Monument, CO (US); Kevin J. Miller, Bismarck, ND (US)

(21) Appl. No.: 12/592,397

(22) Filed: Nov. 24, 2009

(51) Int. Cl. F16L 41/14

(52) U.S. Cl. 285/212

(57) ABSTRACT

A hybrid port comprising a bore having a diameter, a first tapered surface having a cone angle α in the range of approximately 37° to approximately 45°, a second tapered surface having a cone angle β of approximately 12°, the first tapered surface disposed immediately proximate to the bore, and a threaded inner surface disposed axially between the first tapered surface and the second tapered surface.

### FIELD OF THE INVENTION

The invention relates to a hybrid tube connector port, and more particularly, to a hybrid tube connector port comprising a first and second tapered surface for engaging different types of tube connectors.

### BACKGROUND OF THE INVENTION

Generally, for the purpose of forming a tube joint or hose coupling, a male portion engages a port. The shape of the male portion and cooperating port are designed to allow ease of connection while providing a suitable pressure seal.

Various joints and coupling are known, however, in each instance a particular male connector will only mate with the appropriate corresponding same style port. In other words, mixing connector styles is not possible since one style is not interchangeable with another, which limits system flexibility. Hence, it is not possible to use an SAE MALE BOSS connector with a SAE 37 DEGREE port.

It is known that standard SAE male boss fittings are susceptible to leakage after pressure, temperature and vibration excursions. This can cause equipment manufacturers to either over torque SAE male boss fittings (potentially resulting in stripped threads) or to use more costly longer threads (SAE male boss heavy) particularly when ports are machined into aluminum.

It is also known that male boss swivel port fittings (SAE reference) are prone to leakage and damage after pressure, temperature and vibration excursions. These issues can be accentuated by the designs of these fittings which comprise of a threaded male stud with an o-ring followed by a clinched washer followed by a second thread and lock nut. The weak element is the washer clinching process, if this is not done accurately gaps behind the o-ring can exist which lead to o-ring extrusion further shortening life of the fitting.

Representative of the art is U.S. Pat. No. 5,516,157 which discloses an improved hydraulic coupling which forms contact seals to fluidly connect a tapered port with a tube having a threaded connecting portion. The contact seals may be metal-to-metal seals, or alternatively may include a resin polymer element. For connecting a tube directly in the port, one embodiment of the invention includes an outwardly extending lip on an expanded portion of the tube and a tube nut rim wherein the tube nut engages the expanded portion and by tightening the tube nut, the tube lip deforms on the tapered port and the tube nut rim deforms on both the tapered port and the tube. Optionally, o-rings may be added to provide additional seals. The coupling may be designed not to seal without the application of tool generated torques.

What is needed is a hybrid tube connector port comprising a first and second tapered surface for engaging different types of tube connectors. The present invention meets this need.

### SUMMARY OF THE INVENTION

The primary aspect of the invention is to provide a hybrid tube connector port comprising a first and second tapered surface for engaging different types of tube connectors.

Other aspects of the invention will be pointed out or made obvious by the following description of the invention and the accompanying drawings.

The invention comprises a hybrid port comprising a bore having a diameter approximately corresponding to the diameter of a tube, a first tapered surface having a cone angle α of approximately 37° for engaging a SAE 37 DEGREE connector, a second tapered surface having a cone angle β of approximately 12° for engaging an SAE MALE BOSS connector, the first tapered surface disposed immediately proximate to the bore, and a threaded inner surface disposed axially between the first tapered surface and the second tapered surface.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1(A) and FIG. 1(B) show the prior art.

FIG. 2(A) is a cross-sectional view of the inventive hybrid port.

FIG. 2(B) is a cross-sectional view of an alternate embodiment.

FIG. 2C is cross-sectional view of a hybrid port.

FIG. 2D a split cross-sectional view of a compact hybrid port with shorter threads.

FIG. 3 is a cross-sectional view of the port in FIG. 2A with an MJX tube attached.

FIG. 4A is a cross-sectional view of the port in FIG. 2A with the SAE male boss heavy duty attached.

FIG. 4B is a cross-sectional view of the port in FIG. 2A with the SAE male boss light duty.

FIG. 5 is a cross-sectional view of the port in FIG. 2D with a male SAE 45 fitting attached.

FIG. 6 is a cross-sectional view of a straight tubular coupling assembly engaged with the hybrid port.

FIG. 7 is a cross-sectional view of a bent tube assembly engaged with the hybrid port.

FIG. 8 is a cross-sectional view of a straight coupling assembly engaged with the hybrid port.

FIG. 9 is a cross-sectional view of the port in FIG. 2A with an MJX tube attached.

FIG. 10 is a cross-sectional view of the port in FIG. 2A with the SAE male boss light duty.

### DETAILED DESCRIPTION OF THE PREFERRED EMBODIMENT

The inventive hybrid port allows different components to be used in a system.

In particular, a user is afforded flexibility in selecting components wherein for example a given style, for example, SAE MALE BOSS or SAE 37 DEGREE can each be connected to the hybrid port.

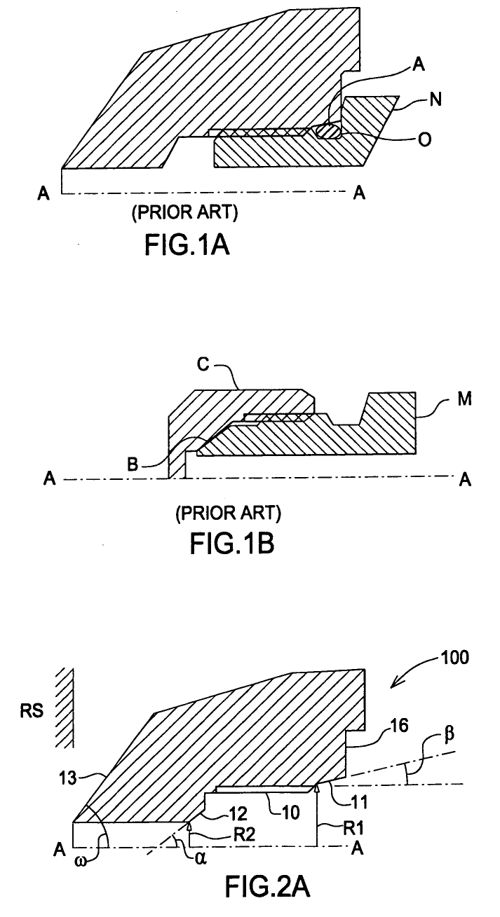

FIG. 1(A) and FIG. 1(B) each show the prior art. FIG. 1(A) shows a male boss (SAE MALE BOSS) standard port connector. A tapered surface A compresses an o-ring O against a nut N. FIG. 1(B) shows a cap C engaged with an SAE 37 Degree male connector

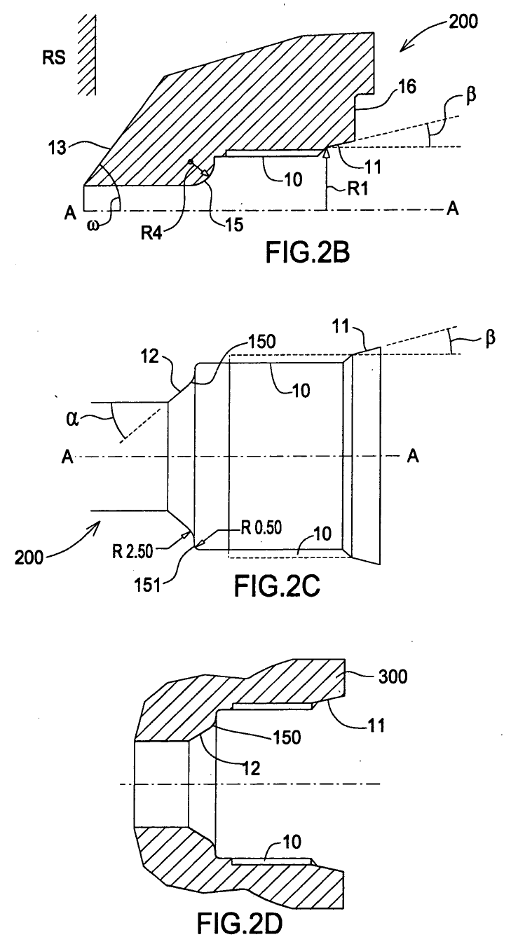

Each of FIGS. 2A and 2B depict an upper half of the hybrid port with respect to an axis A-A, the lower half being identical to the upper half as shown and therefore, the lower half is omitted.

FIG. 2(A) is a cross-sectional view of the inventive hybrid port. A male SAE 37 DEGREE component (not shown) will have a cone to seal engagement with surface 12.

The hybrid port comprises a threaded inner surface 10. Threaded surface 10 provides for a threaded engagement with any threaded tubing connector as described herein.

A tapered surface 11 comprises a cone angle β in the range of 11° to 16°. The preferred angle is 12°. Surface 11 is engagable with a male boss (SAE MALE BOSS) connector o-ring (not shown). The o-ring is known in the art.

A tapered surface 12 comprises a cone angle α of approximately 36.5° up to approximately 40°. The preferred angle is 37°. Surface 12 is engagable with an MJX tube cone (see FIG. 6). Surface 12 is immediately proximate to bore 101. Cone angle α may also comprise approximately 45° so that the connector can interface with a SAE 45 DEGREE Male fitting (not shown).

The radius R1 to surface 11 is greater than radius R2 to surface 12. No portion of surface 12 has a radius which exceeds a radius of surface 11. Radius R2 is one half the diameter of bore 101, see FIG. 6.

Threaded surface 10 is disposed axially with respect to longitudinal axis A-A between surface 11 and surface 12.

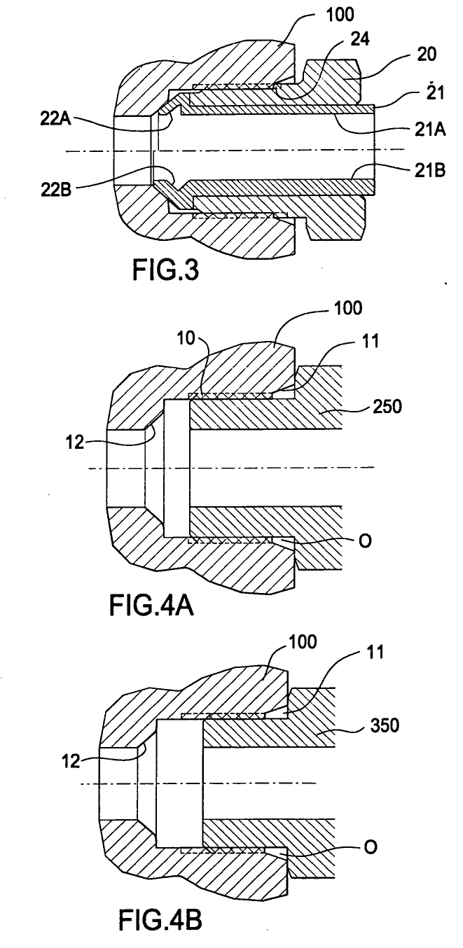

A tapered surface 13 comprises a cone angle ω of approximately 60°, although any angle that would be suitable for a fillet weld is sufficient, for example between 30° and 60°. Surface 13 provides a weldment by which the hybrid port is welded to a receiving surface (RS), see FIG. 3. Weldment surface 13 is known in the art.

In an alternate embodiment the hybrid port is machined directly into the equipment instead of being welded, or is threaded into the equipment by threads on an outer surface.

FIG. 2(B) is a cross-sectional view of an alternate embodiment. In embodiment 200, arcuate surface 15 comprises an arc of radius R4. Surface 15 creates a ring contact with cone 22. This creates a contact arc (circular line) which increases the contact pressure per unit area, which in turn enhances sealing. The arcuate surface 15 will mate with any tube having a cone angle α, for example as described in FIG. 2(A). The embodiment in FIG. 2B and the embodiment in FIG. 2C are able to accept a SAE MALE BOSS fittings an 37 DEGREE male fitting, a 45 DEGREE male fitting and an MJX fitting with either a 45 degree cone or a 37 degree cone

FIG. 2(C) is cross-sectional view of a hybrid port. Radius (R) allows the part to engage several different cones. FIG. 2C is an alternate embodiment to FIG. 2B. This hybrid port has a surface 150 having a radius of approximately R2.50. However, the radius could be in the range of 0.25 mm up to greater than 20 mm depending upon the size of the port.

Surface 12 is disposed at an angle α to a centerline A-A. Surface 12 is connected to arcuate sealing surface 150. Surface 150 comprises a radius of R2.50. Surface 150 engages a tube cone to create a seal. Surface 150 is adjacent to arcuate surface 151 and is adjacent to surface 12. Surface 151 comprises a radius of R0.50, or in other words the radius of surface 150 is approximately 5× larger than the radius of surface 151.

FIG. 2(D) is cross-sectional view of a hybrid port. Radius (R) allows the part to engage several different cones. FIG. 2D is an alternate embodiment to FIG. 2C. This hybrid port is more compact and has a shorter thread allowing it to mate with a standard SAE male 37 and a standard SAE male 45 and an MJX and a Male Boss light fitting

Surface 12 is disposed at an angle α to a centerline A-A. Surface 12 engages an arcuate sealing surface 150. Surface 150 comprises a radius of R2.50. Surface 150 engages a tube to create a seal. Surface 150 is adjacent to arcuate surface 151 and is adjacent to surface 12. Surface 151 comprises a radius of R0.50, or in other words the radius of surface 150 is 5× larger than the radius of surface 151.

FIG. 3 is a cross-sectional view of the port in FIG. 2A with an MJX tube attached. MJX tubing on a swivel nut 20 is engaged with threaded surface 10. Surface 10 comprises a straight thread. Surface 10 may comprise either a left hand or right hand thread.

Reinforced cone 22 for tubing 21 is compressed between surface 12 and end 23 of swivel nut 20, thereby forming a metal to metal seal. Two different tube thicknesses are shown in FIG. 3, namely, 21A and 21B. Ends 22A and 22B engage surface 150. Each end 22A and 22b has a cone angle equal to α as described in FIG. 2A.

FIG. 4(A) is a cross-sectional view of the port in FIG. 2A with the SAE male boss heavy duty attached.

FIG. 4(B) is a cross-sectional view of the port in FIG. 2A with the SAE male boss light duty attached.

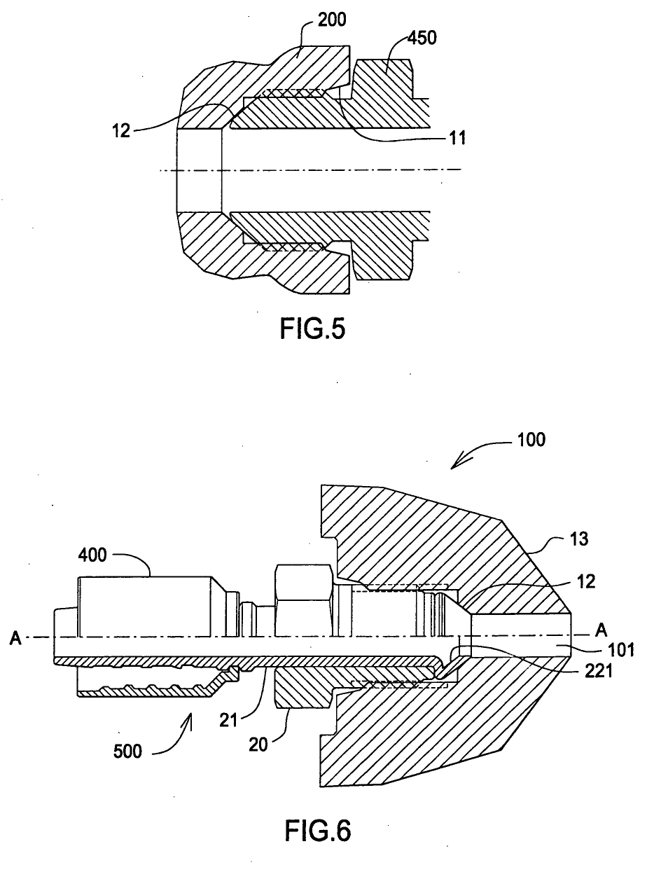

FIG. 5 is a cross-sectional view of the port in FIG. 2D with a male SAE 45 fitting attached. Note this hybrid port 200 will also work with a male SAE 37 fitting.

FIG. 6 is a cross-sectional view of a tubing assembly engaged with the hybrid port. The tubing and connector assembly is as described in FIG. 3. Ferrule 400 is used to connect the assembly to a hose.

Assembly 500 is axially aligned along axis A-A. A bore 101 extends through the port whereby a fluid can flow through the port. Bore 101 having a diameter approximately corresponding to the diameter of tube 21.

The fluid can comprise hydraulic oil, oil, fuel, water, gases or any other fluid which is amenable to flow through tubes or hose.

The new design overcomes the problem of degradation of the SAE male boss fitting sealing capability under pressure, temperature and vibration by utilizing a metal to metal seal which has a smaller wetted sealing area than that of a male boss port.

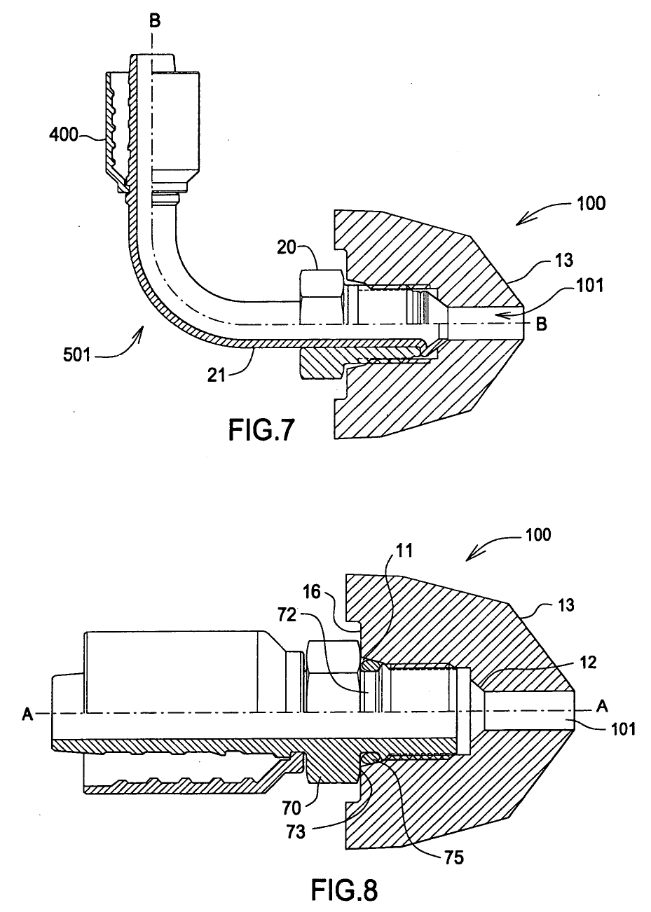

FIG. 7 is a cross-sectional view of a tubing assembly engaged with the hybrid port. The components are as described in FIG. 6, with the exception that a 90° bend is present in tubing 21 along a tubing centerline B-B.

This design overcomes the problems caused by degradation of the SAE male boss adjustable fitting sealing that depend on a clinched washer to prevent the extrusion of the o-ring. The new design allows the fitting to be in the correct rotational position and tightened down resulting in a locked fitting that can simplify equipment assembly and eliminate the need for the male boss adjustable fitting

FIG. 8 is a cross-sectional view of a coupling assembly engaged with the hybrid port. An SAE MALE BOSS male connector 70 is engaged with the port 100. O-ring 75 is compressed between surface 11 and circumferential outer surface 72, thereby forming a pressure seal between the port and the connector 70. Flange surface 73 is in metal to metal contact with port surface 16 which contact determines full engagement of the connector with the port.

Connector 70 is fully compatible with the hybrid port. When used with a connector 70 surface 12 is not in contact with the connector 70.

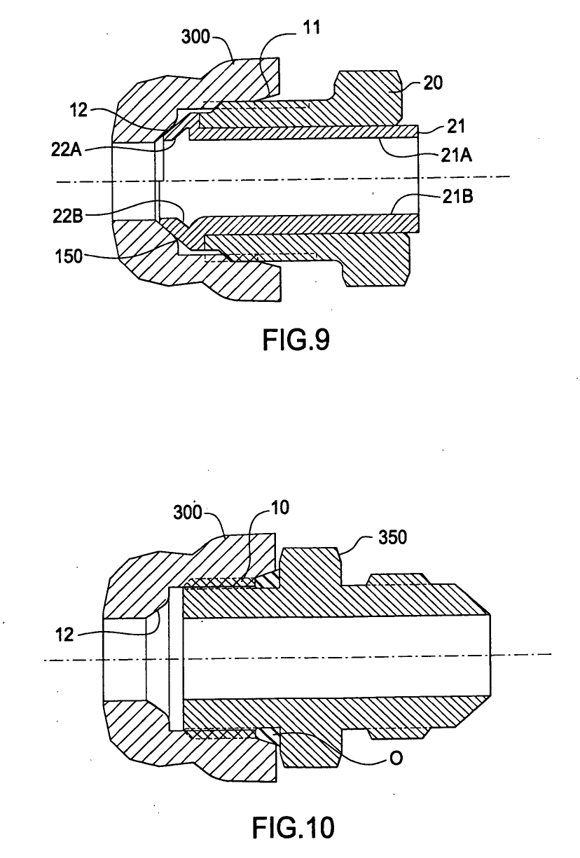

FIG. 9 is a cross-sectional view of the port in FIG. 2D with an MJX tube attached. MJX tubing on a swivel nut is engaged with threaded surface 10. Surface 10 comprises a straight thread. Surface 10 may comprise either a left hand or right hand thread.

Reinforced cone 22 for tubing 21 is compressed between surface 12 and end 23 of swivel nut 20, thereby forming a metal to metal seal. Two different tube thicknesses are shown in FIG. 3, namely, 21A and 21B. Ends 22A and 22B engage surface 150.

FIG. 10 is a cross-sectional view of the port in FIG. 2D with the SAE male boss 350 light duty attached.

Although a form of the invention has been described herein, it will be obvious to those skilled in the art that variations may be made in the construction and relation of parts without departing from the spirit and scope of the invention described herein.

We claim:

1. A hybrid port comprising:
a bore having a diameter;
a first tapered surface (12) having a cone angle α in the range of approximately 37° to approximately 45°;
a second tapered surface (11) having a cone angle β of approximately 12°;
the first tapered surface disposed immediately proximate to the bore; and
a threaded inner surface (10) disposed axially between the first tapered surface and the second tapered surface.

2. The hybrid port as in claim 1, wherein the threaded inner surface comprises a straight thread.

3. The hybrid port as in claim 1 further comprising a weldment surface (13) for attaching the hybrid port to a mounting surface.

4. The hybrid port as in claim 1, wherein the second tapered surface has a radius (R1) which is greater than a first tapered surface radius (R2).

5. A hybrid port comprising:
a bore having a diameter;
an arcuate sealing surface (15) disposed immediately adjacent the bore;
a tapered surface (11) having a cone angle β of approximately 12°; and
a threaded inner surface (10) disposed axially between the arcuate surface and the tapered surface.

6. The hybrid port as in claim 5 further comprising a second surface (12) having a cone angle α in the range of approximately 37° to approximately 45°.

7. The hybrid port as in claim 5 further comprising a second arcuate surface (151) disposed between the arcuate sealing surface and the threaded inner surface.

8. A hybrid port comprising:
a bore having a diameter;
a first tapered surface (12) having a cone angle α in the range of approximately 37° to approximately 45°;
a second tapered surface (11) having a cone angle β of approximately 12°;
an arcuate sealing surface (150) disposed immediately adjacent the first tapered surface and having a radius (R) in the range of approximately 0.25 mm to approximately 20 mm;
the first tapered surface disposed immediately proximate to the bore; and
a threaded inner surface (10) disposed axially between the first tapered surface and the second tapered surface.

9. The hybrid port as in claim 8 further comprising a second arcuate surface disposed between the arcuate sealing surface and the threaded inner surface, the second arcuate surface having a radius R/5.

10. A hybrid port comprising:
a bore having a diameter;
a first arcuate sealing surface;
a tapered surface having a cone angle β of approximately 12°;
the arcuate surface disposed immediately proximate to the bore; and
a threaded inner surface disposed axially between the arcuate surface and the tapered surface.

11. The hybrid port as in claim 10 further comprising a second tapered surface adjacent the first arcuate sealing surface, the second tapered surface having a cone angle α in the range of approximately 37° to approximately 45°
